(19) United States
(12) Patent Application Publication
(10) Pub. No.: US 2020/0327711 A1
(43) Pub. Date: Oct. 15, 2020

(54) SYSTEM AND METHODS FOR GENERATING AUGMENTED REALITY DISPLAYS OF WEATHER DATA

(71) Applicant: August Camden Walker, Washington, DC (US)

(72) Inventor: August Camden Walker, Washington, DC (US)

(21) Appl. No.: 16/728,835

(22) Filed: Dec. 27, 2019

Related U.S. Application Data
(60) Provisional application No. 62/751,919, filed on Oct. 29, 2018.

(51) Int. Cl. G06T 13/60; G06T 19/00; G06T 17/05; G06K 9/62; G01W 1/00

(52) U.S. Cl. CPC G06T 13/60; G06T 19/006; G01W 2203/00; G06K 9/6221; G01W 1/00; G06T 17/05

(57) ABSTRACT

A computer-implemented method of generating augmented reality for displaying weather data with confidence intervals through an augmented reality layer functionality coupled to a computing device having a user interface so that the augmented reality layer is configured to process online weather model data and location service data and therefrom virtually represent at least one weather condition, through the augmented reality layer functionality, on the user interface, wherein the at least one weather condition is consistent with a location of the user interface and the online weather model data and the location service data.

### CROSS-REFERENCE TO RELATED APPLICATION

This application claims the benefit of priority of U.S. provisional application No. 62/751,919, filed 29 Oct. 2018, the contents of which are herein incorporated by reference.

### BACKGROUND OF THE INVENTION

The present invention relates to systems and methods of displaying weather data and, more particularly, a system and methods of generating augmented reality for displaying weather data.

Consumers of weather news, data, forecasts, and other weather-related information do not know where they are located on the displayed map at the time of receiving such information. As a result, in times of severe weather forecasts, users can be negatively impacted by the weather and not know how to plan to take damage-preventative action or to take life-saving action once the severe weather is upon them, which may be too late. For example, if one sees a hurricane on a forecast, but do not know where they are in relation to the hurricane they may not know how to evacuate or maybe that they should not evacuate. There has long been a disconnect with “WHERE AM I” [on a displayed map] and “WHAT DO I DO” [for protection] during weather events. Giving users an immersive experience of the weather forecast can help users comprehend and decrease their vulnerability to severe weather conditions before it is too late. This immersive experience can be very helpful for individuals who have never experienced certain severe weather conditions before. A weather condition can include one of the following: precipitation, temperature, wind direction and speed, and the like.

Augmented reality weather data has not been used as an interactive, real-time, location-specific option for weather consumers; currently, consumers can only watch it on T.V. but cannot experience it immersively and in their surroundings. If such augmented reality capabilities were married to a system providing interactive, real-time, location-specific information, important decisions could be made quicker and informed with illuminated easily-seen augmented reality weather forecasts on a user's smart device display screen. Thereby, enabling users to “view” the weather impacting the structure they are currently occupying, by seeing outside “through the walls” (which are removed by way of augmented reality technology) currently or in the near-term forecast. Even with weather model data being deterministic, the on-screen meteorologist who would be broadcasting live can also give confidence intervals in the forecast and use more qualifiers if the weather data is not sound or to be trusted completely. In addition to any broadcast meteorologist, the software application embodied in the present invention may provide confidence interval displays in the form of an ‘H’ for High, a ‘M’ for Medium, and a “L” for Low in the upper right corner of the home screen/user interface.

As can be seen, there is a need for a system and methods of generating augmented reality for displaying weather data. The augmented reality (AR) embodied in the present invention is adapted to take weather model data and immersively display the related weather's impact and interaction with the structure housing the user and their computing device. Location services on user's device ensures they are seeing what weather is forecast at their exact location in the near term. No longer will they ask a meteorologist if their location is in a problem area, as the augmented reality layer will show what they can expect—i.e., there is no need to look immediately at graphics or take out a map, though those layers are available if the user would like to opt-in to more informational context for their forecast. If severe weather such as flash flood or hurricane are forecast, the software application will illuminate paths outside their hotel or house to take them away to safety. This essentially instructs them that SPECIFIC life-saving ACTION is needed and makes it easy to execute evacuation.

Augmented reality has been used in weather studios but never as embodied in the software application wherein the meteorologist is broadcasting outdoors in the weather, live, taking Q&A from users, and visually representing the location-specific weather in the forecast so that users can see what the near-term weather would look like if they were outside in it. Further, location services on mobile devices allows users to have the augmented reality (AR) reflect, based on their exact location, what and how the weather is impacting where they are—e.g., with rain or hail if that is indeed in the forecast.

In short, the present invention overlays a virtual “portal” or “window” to show future weather impacting a specific location.

### SUMMARY OF THE INVENTION

In one aspect of the present invention, a computer-implemented method of generating augmented reality for displaying weather data: providing an augmented reality layer functionality coupled to a computing device having a user interface; the augmented reality layer functionality adapted to process online weather model data and location service data; and virtually representing at least one weather condition, through the augmented reality layer, on the user interface, wherein the at least one weather condition is consistent with a location of the user interface based on the online weather model data and the location service data. And further comprising an image capturing device operatively associated to the augmented reality layer functionality, wherein the augmented reality layer functionality is adapted to represent the at least one weather over at least one image captured by the image capturing device, wherein the at least one image is a self-image of a user, wherein the at least one image is a structural image of a structure surrounding the user interface, and a representation of a real-time meteorological presentation that is interacted with through the user interface, wherein the augmented reality layer functionality is configured to represent an evacuation route from the location of the user interface based to on a location of the at least one weather condition.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention, illustrating a high confidence weather forecast, as indicated through the ‘H’ in upper-right corner;

FIG. 2 is a schematic view of an exemplary embodiment of the present invention, illustrating a medium confidence weather forecast through the ‘M’ in upper-right;

FIG. 3 is a schematic view of an exemplary embodiment of the present invention, illustrating a partly cloudy forecast when clicking the upper-right camera icon. The present invention is also configured to virtually “tear down” the structural walls surrounding a user of the software application to reveal a “window” or “portal” of augmented reality of the outdoor weather, immersing the user in the incoming weather forecast. For user clarity, current conditions may be added in the lower right, as well as an icon of conditions in the lower left. There may also be a consistent camera-type icon in the upper right in all areas of the user interface operatively associated with the software application; this way users can scroll between outside forecasts and selfie-camera, which then immerses them in the forecast weather. The resulting representation is shareable and social media-ready;

FIG. 4 is a schematic view of an exemplary embodiment of the present invention, demonstrating forecast representation which can be accessed from the upper-right camera icon. In this exemplary embodiment, the weather conditions example rendered by the augmented reality layer 10 is light rain conditions brought into the viewers surroundings, as seen through the viewer's mobile device's rear-facing camera;

FIG. 5 is a schematic view of an exemplary embodiment of the present invention, demonstrating a low confidence weather forecast, with a ‘L’ in upper-right corner. The present invention communicates weather forecast confidence with both COLOR and LETTER symbols concurrently. When forecast confidence is “low”, there is more that can go wrong with the forecast, since weather model data cannot agree on how the atmosphere will behave. It's when the atmosphere is in its least-predictable mode, usually when it's transitioning into an unsettled pattern;

FIG. 6 is a schematic view of an exemplary embodiment of the present invention, demonstrating a selfie-camera forecast immersion functionality. Ready to share on social media. This screen can be accessed via two different clicks. Either upper-right camera icon or a colored center “record” button. It would be same animated augmented reality as seen in the rear-facing camera that “tears down” the surrounding walls to show a window of weather into the outside world that the user is immersed in and that can share with friends on social media to communicate your mood combined with the current weather conditions;

FIG. 7 is a schematic view of an exemplary embodiment of the present invention;

FIG. 8 is a schematic view of an exemplary embodiment of the present invention; and

FIG. 9 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a computer-implemented method of generating augmented reality for displaying weather data through an augmented reality layer functionality coupled to a computing device having a user interface so that the augmented reality layer is configured to process online weather model data and location service data and therefrom virtually represent at least one weather condition on the user interface, through the augmented reality layer functionality, wherein the at least one weather condition is consistent with a location of the user interface and the online weather model data and the location service data.

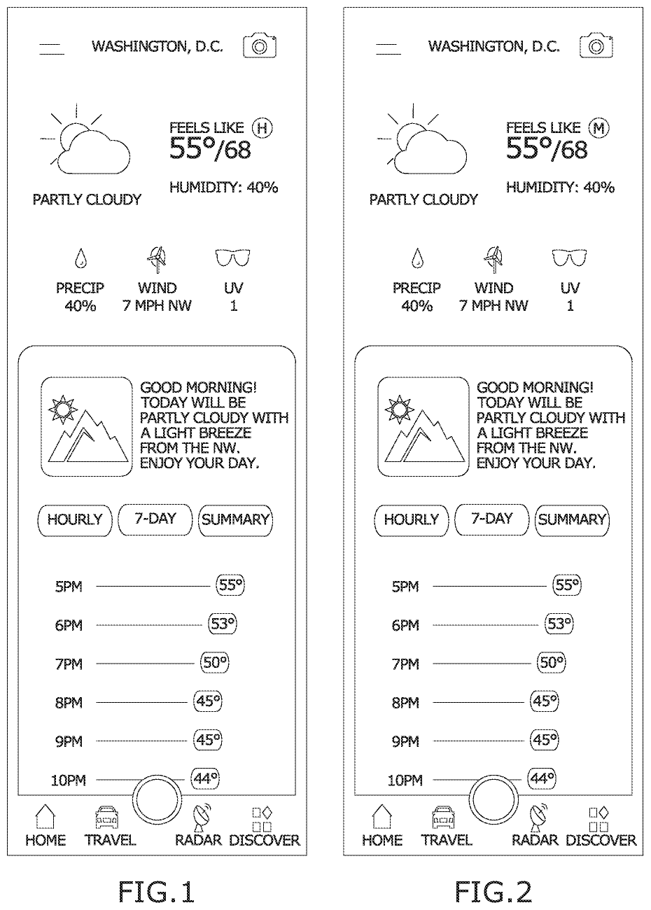

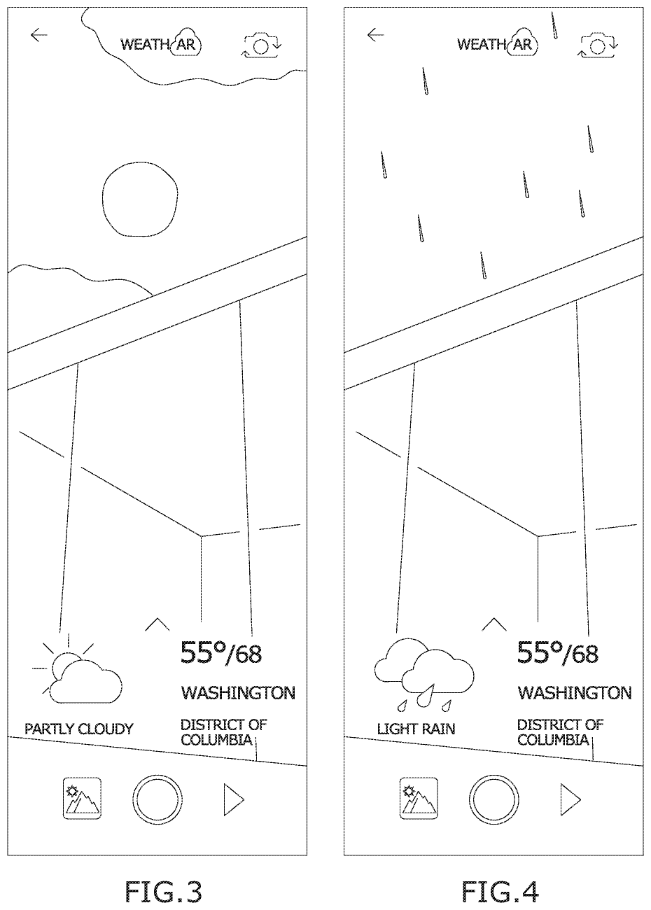

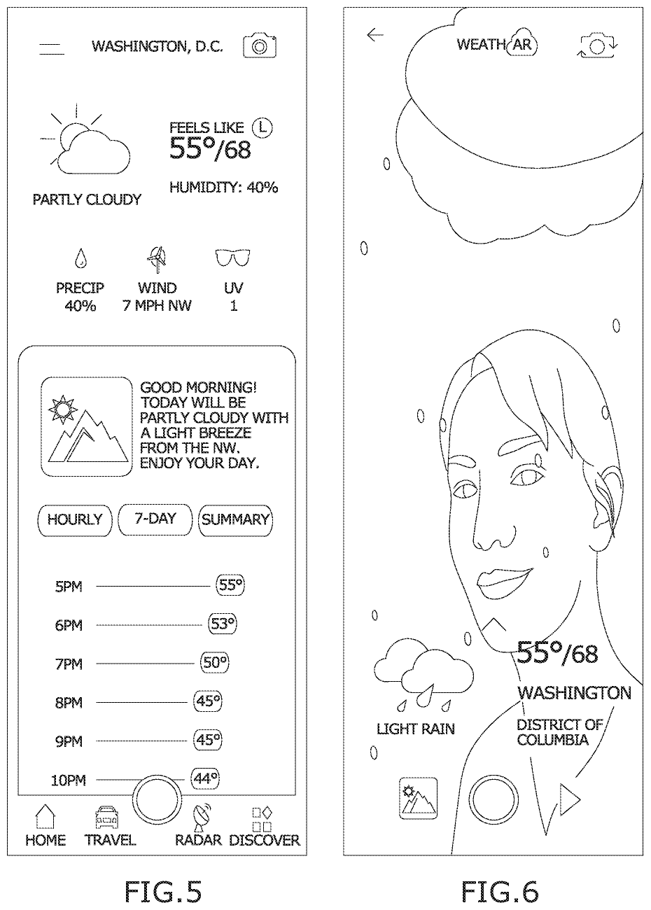

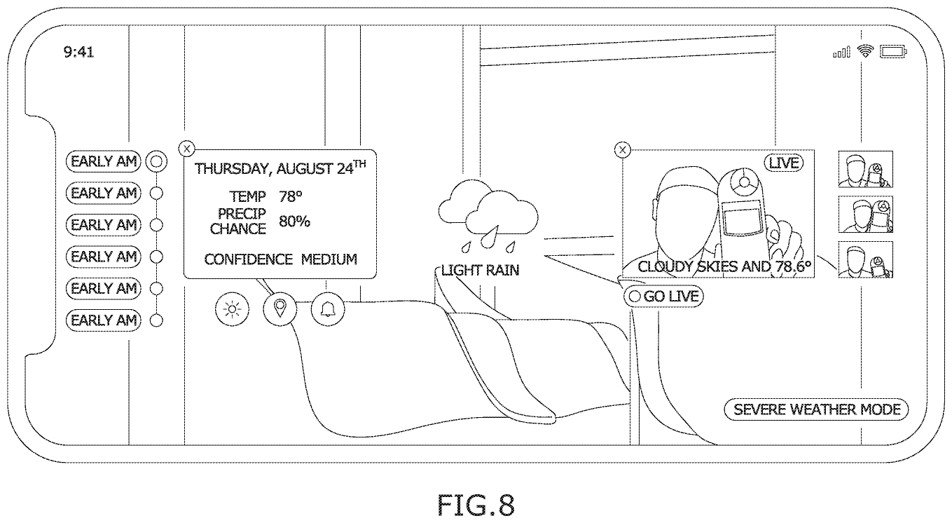

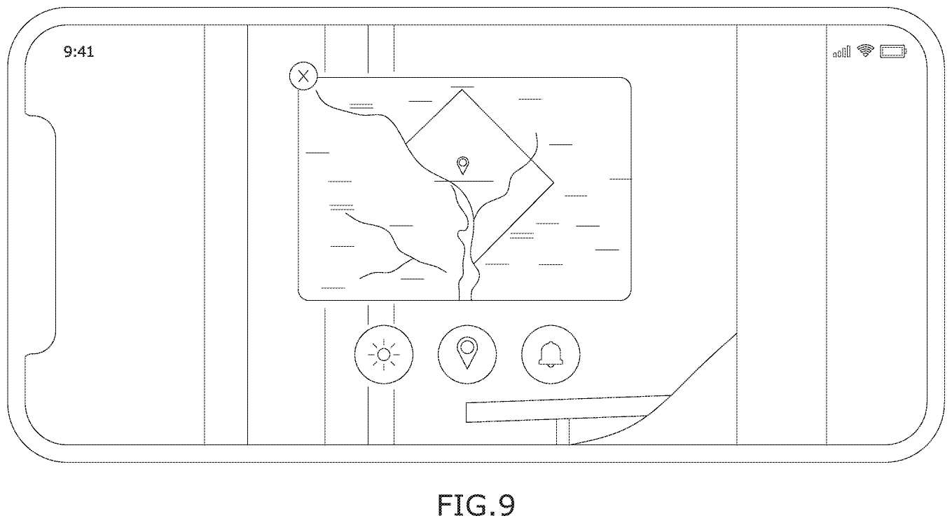

Referring now to FIGS. 1 through 9, the present invention may include at least one computer with a user interface. The computer may include at least one processing unit coupled to a form of memory. The computer may include, but not limited to, a microprocessor, a server, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

The computer is coupled to a video input and output device, such as a camera. The software application provides an augmented reality layer configured to ingest and process weather model data with numerical output, such as data from all airports. The software application may also be configured to process camera roll or digital graphics photo input.

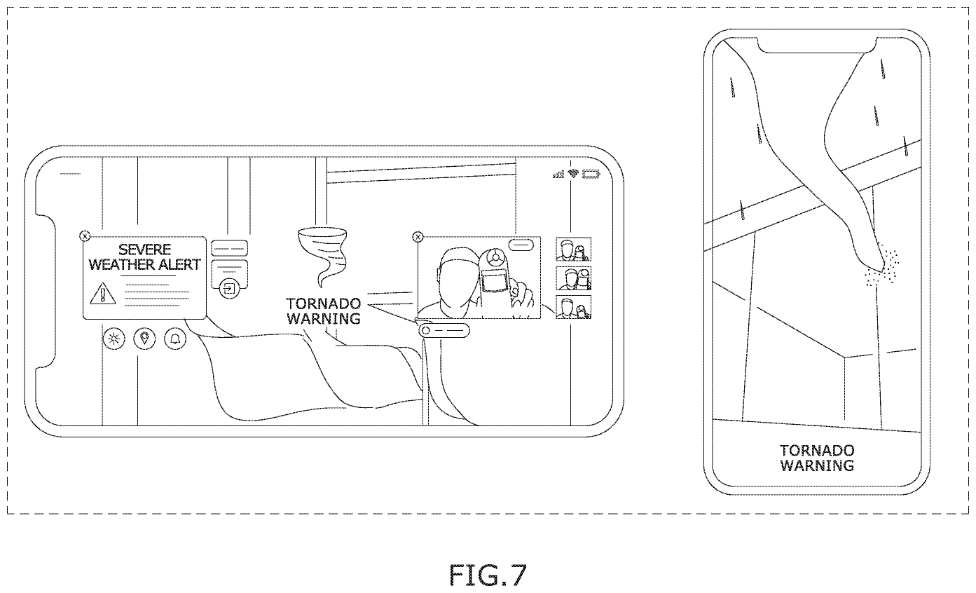

Many sections will be displayed at once on the same software application generated screen during live broadcast. Simultaneously, the software application enables the following functionality: 1) Meteorologist answering live Q&A and narrating regional weather story; 2) Graphics and maps section to show the synoptic setup for why the region's weather is what it is; 3) user's current location as pulled from their location services; and 4) using their camera input, to create an augmented reality layer 10, as illustrated in FIG. 7.

In one embodiment, a broadcaster's camera records his livestream broadcast as the user's camera will interface with the present invention's augmented reality layer 10 to “show” outside weather coming their way, as if taking down their walls and showing them rain, hail, tornado, flood inundating their home, or sunshine coming to their location, as the live meteorologist narrates the regional weather and toggles through the short-term forecast. The augmented reality layer 10 will create the illusion as if there are no walls there—between user and the weather outside. Live video can also be stored in a video queue for watching later. Additionally, users, if they subscribe, can be video content creators as well, and have a series of non-live videos uploaded into the app's queue. Users can even subscribe to their favorite video content providers, receiving push alerts when they go Live—or push alerts with nearest meteorologist going live based on their location—with a subscription fee.

Note that an evacuation route can be illuminated outside on the road, but the user would have to use their mobile device's camera to “cut through” their walls and follow the highlighted road outside. The user can also pop-out the software application's evacuation route data into Google Maps or Waze, for instance, if the user prefers.

A method of making the present invention may include the following. Software developers will have to be involved while a meteorologist points them toward what weather model, evacuation route, flood plain, and hurricane storm surge data should be ingested into the AR portion of the application. Augmented Reality developers should be able to help build the software application for live broadcast, graphical map displays, and augmented reality weather displaying at users' locations based on their device locations, and provide live two-way Q&A communication capability with users. Backend technical development is also aiming to simulcast to more than one social media outlet at one time, but all questions coming to the Live meteorologist will be viewable concurrently, regardless of social media platform. A lot of coding and application development would be involved, along with expertise in weather models and AR.

In standard practice, all elements are necessary. The present invention will provide AR forecast content without subscription. We believe it important to feature this front and center. For instance, an AR “flood” at the user's location within the short-term forecast information displayed, should give them time to think and plan. We believe that the present invention embodies the belief that it is best to bring the weather to the user—into their surroundings. This should spur action when needed during severe weather, more so than just looking at a 2-dimensional forecast icon or a theoretically forecasted AR “flood” inundating a meteorologist they would watch on a T.V. screen. Further, illuminating evacuation routes during severe weather is also a crucial element to spur weather consumers' action, wherein the evacuation route is from the location of the user interface/computing device to a geographical extent of said severe weather. Finally, the user's location services need to be enabled to get their personalized AR layer at their desired location for near-term weather.

A method of using the present invention may include the following. The system and methods of generating augmented reality for displaying weather data augmented reality layer 10 functionality disclosed above may be provided. A user would enable location services on their device and downloaded software application. Broadcasts or uploaded videos can be announced in advance and notifications, if the user has them enabled and allowed through their device, will push out alerts when a meteorologist or paid subscriber is Live broadcasting with Q&A. Maps and AR will remain active during videos or broadcasts, so as to keep the software application as an immersive experience. The choices of information can be opted-into for greater context but will not all display at one time, so as to not overwhelm the user.

Additionally, in a further iteration for this invention, medical practitioners can use this for remote consultation or surgeries. They would be live on the screen, able to take live Q&A, while projecting an AR layer of a new limb or other device they want to talk about—specifically at the user's location or even on a specific place on their body. Graphics, tools, maps can also be used in medical field but also engineering could use the augmented reality layer 10 to render a tunnel or bridge while someone is remotely narrating the presentation to those onsite and best able to see this new proposed construction, through the augmented reality layer 10. Again, graphics and drawings can be beamed through the software application to ensure no gaps in communication—verbally, with concurrent AR layer.

Also, through the software application, hardware may be developed to better handle the broadcaster's needs; specifically, a hardware device to manage and toggle through the AR, the graphics, and questions streaming into the broadcast. With larger tablet devices, professional meteorologists and paid subscribers should be able to see and control more than what a user/consumer of the broadcast sees with AR and graphics.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. Wearable technology is also progressing and this application can be used on such hardware as that technology format evolves. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer-implemented method of generating augmented reality for displaying weather data:
providing an augmented reality layer functionality coupled to a computing device having a user interface;
the augmented reality layer functionality configured to process online weather model data and location service data; and
virtually representing at least one weather condition on the user interface, through the augmented reality layer functionality, wherein the at least one weather condition is consistent with a location of the user interface based on said online weather model data and the location service data.

2. The computer-implemented method of claim 1, further comprising an image capturing device operatively associated to the augmented reality layer functionality, wherein the augmented reality layer functionality is configured to represent the at least one weather condition over at least one image captured by the image capturing device.

3. The computer-implemented method of claim 2, wherein the at least one image is a self-image of a user.

4. The computer-implemented method of claim 2, wherein the at least one image is a structural image of a structure surrounding the user interface.

5. The computer-implemented method of claim 2, further comprising a representation of a real-time meteorological presentation that is interacted with through the user interface.

6. The computer-implemented method of claim 2, wherein the augmented reality layer functionality is configured to represent an evacuation route from the location of the user interface based at least in part on a geographical extent of the at least one weather condition.

7. The computer-implemented method of claim 2, wherein the augmented reality layer functionality is configured to represent on the user interface one of a plurality of confidence intervals associated with each of the at least one weather condition.

8. The computer-implemented method of claim 7, wherein the plurality of confidence intervals comprises a ‘H’, a ‘M’, and a “L” represented on the user interface, wherein the ‘H’ represents a confidence level higher than the ‘M’, and the ‘M’ represents a confidence level higher than the ‘L’.
